(19) United States
(12) Patent Application Publication
(10) Pub. No.: US 2023/0287607 A1
(43) Pub. Date: Sep. 14, 2023

(54) FLEXIBLE, ARC RESISTANT, FLUID REPELLANT, HIGH TEMPERATURE AND ABRASION RESISTANT, WRAPPABLE TEXTILE SLEEVE AND METHOD OF CONSTRUCTION THEREOF

(71) Applicant: FEDERAL-MOGUL POWERTRAIN LLC, Northville, MI (US)

(72) Inventors: Thibaut Lesur, Clairoix (FR); Marianne Khantouche, Bourges (FR); Amelie Simoens, Compiegne (FR); Tianqi Gao, Malvern, PA (US); Kamel Fennell, Plymouth Meeting, PA (US); Alexis Zambino Mason, Flagstaff, AZ (US); Xiaodan Qiu, Phoenixville, PA (US)

(21) Appl. No.: 18/118,611

(22) Filed: Mar. 7, 2023

Related U.S. Application Data
(60) Provisional application No. 63/317,891, filed on Mar. 8, 2022.

(51) Int. Cl. D03D 1/00; D03D 15/513; D03D 3/02

(52) U.S. Cl. CPC D03D 1/0043; D03D 3/02; D03D 15/513

(57) ABSTRACT

A wrappable sleeve has a wall including an interlaced layer providing an inner surface and an opposite outer surface extending widthwise between opposite edges and extending lengthwise between opposite ends. The opposite edges are wrappable about a central longitudinal axis to bound the elongate member within a cavity bounded by the inner surface. The interlaced layer is formed of yarns interlaced with one another, wherein a least some of the yarns include multifilaments resistant to heat and monofilaments resistant to heat. The wall further includes a silicone-based coating adhered to the outer surface of the interlaced layer, and a closure member fixed along one of the opposite edges. The closure member has an adhesive surface configured to maintain the opposite edges of the wall in overlapping relation with one another.

### CROSS-REFERENCE TO RELATED APPLICATION

This application claims the benefit of U.S. Provisional Application Serial No. 63/317,891, filed Mar. 8, 2022, which is incorporated herein by reference in its entirety.

### BACKGROUND OF THE INVENTION

### 1. Technical Field

This invention relates generally to textile sleeves for protecting elongate members, and more particularly to flexible, wrappable textile sleeves having arc resistant, abrasion resistant, heat resistant and fluid repellent properties.

### 2. Related Art

It is known to contain and protect elongate members, such as wires and wire harnesses, for example, in circumferentially continuous, tubular textile sleeves to provide protection to the cables, wires, and hoses. However, these sleeves are generally challenging to assemble about elongate members to be protected due to their having a fixed cavity size and to having to be slipped axially over the elongate member to be protected. Further yet, in order to achieve the multiple, different types of desired protection, such as arc resistance, fluid resistance, abrasion resistance, heat resistance, known protective sleeves typically have multiple layers, with each of the layers being specifically provided for a different type of protection. Although the aforementioned multilayer sleeves may provide suitable protection against various environmental conditions, unfortunately they are bulky, having a thick, multilayered wall with different types of yarns being provided in each layer, thereby requiring an increased volume of space, and further, they tend to be relatively heavy and exhibit low flexibility. Further yet, having to include multiple layers can prove problematic in some applications, particularly applications requiring routing cables, wires or hoses through tight, winding areas, as well as applications having weight restrictions, such as aircraft and aerospace applications, for example.

### SUMMARY OF THE INVENTION

One aspect of the invention provides a wrappable sleeve for routing and protecting an elongate member from arcing, exposure to abrasion, thermal conditions including high heat and fire, fluid (water/fuel) ingress, and other environmental conditions, such as contamination, and protects against fluid absorption into a wall of the sleeve is provided. The wrappable sleeve has a wall including an interlaced layer having an inner surface and an opposite outer surface extending widthwise between opposite edges and extending lengthwise between opposite ends. The opposite edges are configured to be wrapped about a central longitudinal axis to bound the elongate member within a cavity bounded by the inner surface. The interlaced layer is formed of yarns interlaced with one another, wherein a least some of the yarns include multifilaments resistant to heat and monofilaments resistant to heat. The wall further includes a silicone-based coating adhered to the outer surface of the interlaced layer, and a closure member is fixed along one of the opposite edges. The closure member has an adhesive surface configured for adhesion to an outer surface of the wall to maintain the opposite edges of the wall in overlapping relation with one another.

In accordance with another aspect of the invention, the yarns can including warp yarns extending generally parallel to the central longitudinal axis and weft yarns extending generally transversely to the central longitudinal axis, with the warp yarns being woven with the weft yarns.

In accordance with another aspect of the invention, the warp yarns can be provided entirely from multifilaments resistant to heat and the weft yarns can be provided including monofilaments resistant to heat.

In accordance with another aspect of the invention, the weft yarns can be provided including monofilaments resistant to heat and multifilaments resistant to heat.

In accordance with another aspect of the invention, the multifilaments resistant to heat can be provided as meta-aramid.

In accordance with another aspect of the invention, the warp multifilaments resistant to heat can be provided having a denier between about 100-3000 and the weft multifilaments resistant to heat can be provided having a denier between about 50-1000.

In accordance with another aspect of the invention, the monofilaments resistant to heat can be provided having a diameter between about 0.1-0.5 mm.

In accordance with another aspect of the invention, the monofilaments resistant to heat can be provided as PEEK.

In accordance with another aspect of the invention, the silicone-based coating can include at least one, or both of a flame retardant and a heat stabilizer.

In accordance with another aspect of the invention, the silicone-based coating has a thickness between about 0.1-3.0 mm.

In accordance with another aspect of the invention, the closure member can be provided as a silicone pressure sensitive adhesive.

In accordance with another aspect of the invention, the silicone pressure sensitive adhesive is configured for fixed adhesion to the inner surface of the interlaced layer and to an outer surface of the silicone-based coating.

In accordance with another aspect of the invention, the closure member can include a silicone amalgamating tape.

In accordance with another aspect of the invention, the closure member can include a silicone pressure sensitive adhesive bonded to the silicone amalgamating tape.

In accordance with another aspect of the invention, a method of constructing a wrappable sleeve for routing and protecting an elongate member from arcing, exposure to abrasion, thermal conditions including high heat and fire, fluid (water/fuel) ingress, and other environmental conditions, such as contamination, and to protect against fluid absorption into a wall of the wrappable sleeve, is provided. The method includes interlacing heat-resistant yarn to form an interlaced layer of a wrappable wall having opposite edges extending lengthwise between opposite ends, with the opposite edges being configured to be wrapped about a central longitudinal axis to bound the elongate member within an enclosed cavity. The method further includes bonding a silicone-based coating on an outer surface of the interlaced layer. The method further includes fixing a closure member along one of the opposite edges, and providing the closure member having an adhesive surface configured for adhesion to an outer surface of the wall to maintain the opposite edges of the wall in overlapping relation with one another.

In accordance with another aspect of the invention, the method can further include interlacing the yarns with one another in a weaving process, a knitting process, or a braiding process. If woven, the method can further include weaving the yarns including warp yarns extending generally parallel to the central longitudinal axis, with the warp yarns being provided entirely as multifilaments resistant to heat, and weft yarns extending generally transversely to the warp yarns, with the weft yarns including monofilaments resistant to heat.

In accordance with another aspect of the invention, the method can further include providing the weft yarns including both monofilaments and multifilaments resistant to heat.

In accordance with another aspect of the invention, the method can further include providing the warp multifilaments having a denier between about 100-3000 and providing the weft multifilaments having a denier between about50-1000.

In accordance with another aspect of the invention, the method can further include providing the weft monofilaments having a diameter between about 0.1-0.5 mm.

In accordance with another aspect of the invention, the method can further include weaving the warp yarns and the weft yarns in one of a plain, twill, basket, or satin weave pattern.

In accordance with another aspect of the invention, the method can further include weaving the weft monofilaments and multifilaments in alternating relation with one another along the entirety of the length of the wall.

In accordance with another aspect of the invention, the method can further include providing the silicone-based coating having a thickness between about 0.1-3.0 mm.

In accordance with another aspect of the invention, the method can further include providing the silicone-based coating including at least one of a flame retardant and a heat stabilizer.

In accordance with another aspect of the invention, the method can further include providing the closure member including a silicone pressure sensitive adhesive.

In accordance with another aspect of the invention, the method can further include providing the silicone pressure sensitive adhesive being configured for fixed adhesion to the inner surface of the wall and to an outer surface of the wall.

In accordance with another aspect of the invention, the method can further include providing the closure member including a silicone amalgamating tape.

In accordance with another aspect of the invention, the method can further include providing the silicone amalgamating tape having a silicone pressure sensitive adhesive bonded thereto, with the silicone pressure sensitive adhesive being configured for adhesion to an outer surface of the silicone-based coating.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is schematic perspective view of a wrappable sleeve constructed in accordance with one aspect of the invention, with the wrappable sleeve shown wrapped about an elongate member to be protected therein;

FIGS. 2A-2C are end views looking along a central longitudinal axis of the sleeve of FIG. 1 illustrating different embodiments of a closure member for maintaining opposite edges of the wrappable sleeve in fixed, overlapped relation with one another; and

FIGS. 3A-3C illustrate different embodiments of an interlaced layer of the wrappable sleeve of FIG. 1.

### DETAILED DESCRIPTION OF PREFERRED EMBODIMENTS

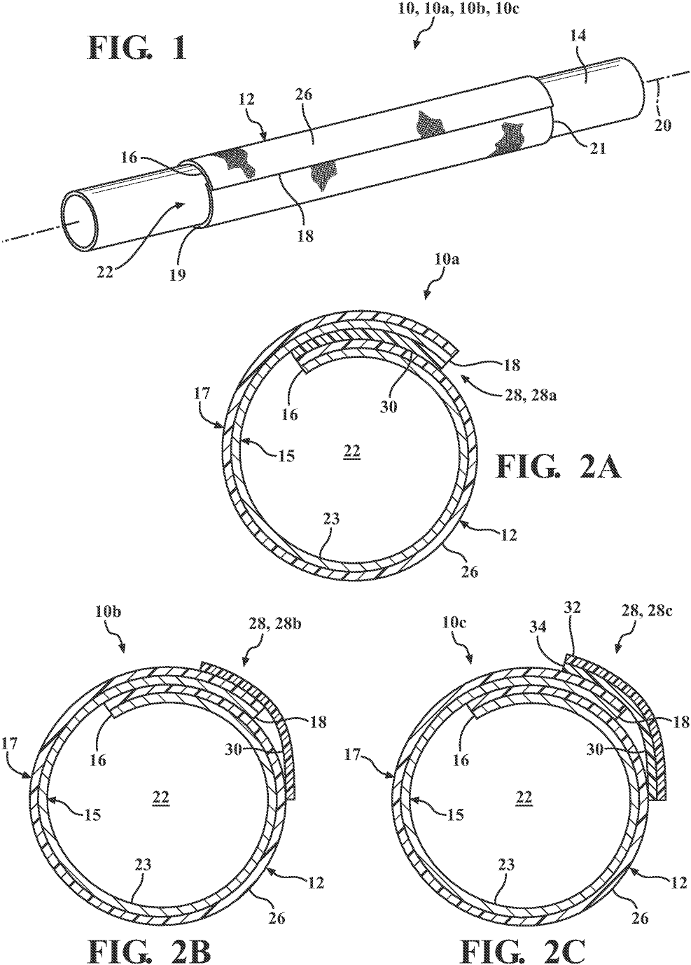

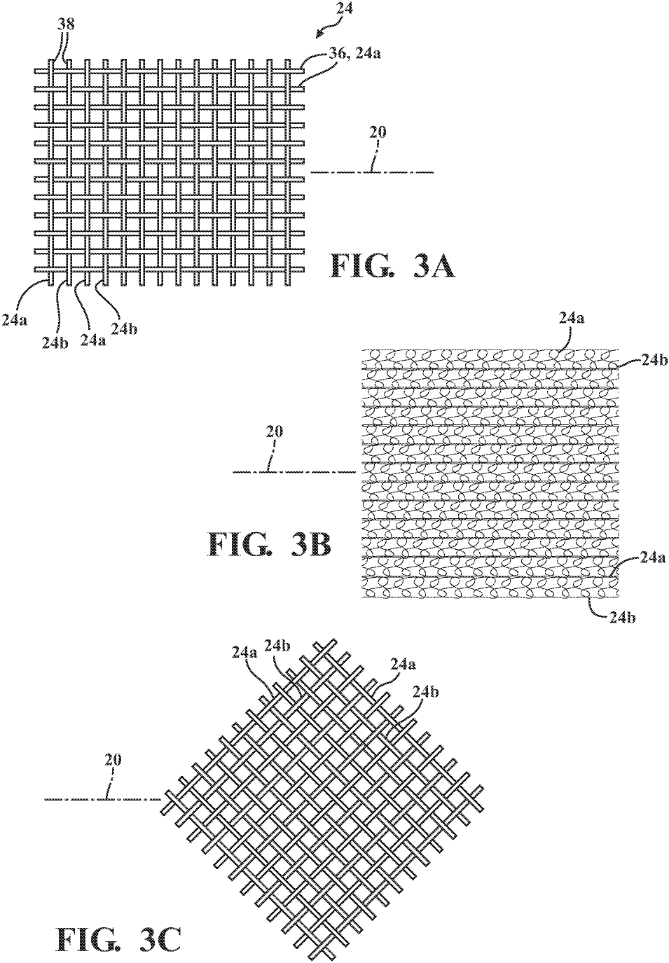

Referring in more detail to the drawings, FIGS. 1 and 2A-2C show a schematic representation of a wrappable (shown wrapped in FIG. 1) textile sleeve, referred to hereafter as sleeve 10a, 10b, 10c, constructed in accordance with different aspects of the invention, wherein sleeves 10a-10c are discussed hereafter generically as sleeve 10, unless otherwise specified. The sleeve 10 has a flexible, wrappable elongate wall 12 for routing and protecting an elongate member(s) 14, such as a cable, wires, and pipe, for example, from exposure to arcing (electrical flow path through an air gap from a cable or wire to another conductor, such that energy of a cable or wire is contained inside the wall 12, thereby preventing the release of energy from the sleeve 10), abrasion, thermal conditions including high heat and fire, fluid absorption and ingress, e.g. water, oil, fuel, and the like, and other environmental conditions, such as contamination. The wall 12 can be constructed having any suitable size, including length and diameter. The wall 12 has an inner surface 15 and an opposite outer surface 17, extending widthwise between opposite edges 16, 18 and lengthwise between opposite ends 19, 21. The opposite edges 16, 18 extend generally parallel to a central, longitudinal axis 20, wherein the edges 16, 18 are wrappable into overlapping relation with one another in “cigarette wrapped” fashion to fully enclose the elongate member 14 within a central cavity 22 bounded by the inner surface 15 of the sleeve 10. The wall 12 has an inner, interlaced textile layer 23 formed of yarns 24 interlaced with one another in one of a woven (FIG. 3A), knit (FIG. 3B), or braided (FIG. 3C) fashion, wherein a least some of the yarns 24 include multifilaments 24a resistant to heat, and monofilaments 24b resistant to heat, thereby allowing the sleeve 10 to withstand exposure to high heat and fire for a predetermined amount of time, including up to about 2 hours or more, while protecting the elongate member 14 against heat damage. A silicone-based coating 26 is adhered to the outer surface 17 of the interlaced textile layer 23, shown as being adhered to the entirety of the outer surface 17, wherein the silicone-based coating 26 enhances the aforementioned levels of protection to the elongate member 14, particularly with regard to the prevention of arc and fluid absorption/ingress. A closure member 28 is fixed along one of the opposite edges (outer edge 18), and has an adhesive surface 30 configured for adhesion to an outer, outwardly facing surface of the silicone-based coating 26 of the wall 12 to maintain the opposite edges 16, 18 of the wall 12 in overlapping relation with one another. Accordingly, the wall 12 and the closure member 28 seal off the cavity 22 against the ingress of fluid, thereby providing the aforementioned protections to the elongate member 14.

The silicone-based coating 26 is a fluid impervious coating, thereby being impervious to water, fuel (e.g. kerosene), oil, and the like, to render the wall 12 fluid impervious as well as fluid repellant. As such, fluid is prevented from being absorbed by the interlaced layer 23, thus, preventing water, fuel and the like from compromising the ability of the sleeve 10 to provide the desired levels of protection. The silicone-based coating 26 can include at least one or both of a flame retardant and a heat stabilizer, and can be provided having a thickness between about 0.1-3.0 mm, thereby contributing to the wall 12 having a narrow profile, thereby enhancing the flexibility and ability to be routed in relatively small, tight spaces.

As shown in FIG. 2A, the closure member 28 can be provided as a silicone pressure sensitive adhesive (PSA) 28a. The silicone PSA 28a is shown configured for fixed adhesion to the inner surface 15 of the textile layer 23 and to an outer surface of the wall 12, shown as being fixed to an outer surface of the silicone-based coating 26. As such, the silicone PSA 28a is sandwiched between the inner surface 15 of the textile layer 23 and the outer surface of the silicone-based coating 26. The silicone PSA 28a can be a double-sided PSA so as to be adhered to the inner surface 15 of the textile layer 23 during manufacture of the sleeve 10 and to the outer surface of the silicone-based coating 26 upon assembly of the sleeve 10 about the elongate member 14. A release film (not shown) can be applied to the PSA surface configured to adhesion to the outer surface of the silicone-based coating 26, thus allowing the release film to be peeled away, when desired, to wrap and fix the sleeve 10 about the elongate member 14.

As shown in FIG. 2B, the closure member 28 can be provided as a silicone amalgamating tape 28b. The silicone amalgamating tape 28b is shown configured for fixed adhesion to the outer surface of the silicone-based coating 26 adjacent the outer edge 18 and to the outer surface of the silicone-based coating 26 adjacent the inner edge 16. As such, the silicone amalgamating tape 28b is exposed in its entirety about the outer surface of the silicone-based coating 26. A release film(s) (not shown) can be applied to an inner surface of the silicone amalgamating tape 28b, as desired, with the release film being configured to be peeled away, when desired, during manufacture of the sleeve 10 and while wrapping and fixing the sleeve 10 about the elongate member 14.

As shown in FIG. 2C, the closure member 28c can be provided similarly as discussed above for the embodiment of FIG. 2B, having a silicone amalgamating tape 32, while also having an inner silicone PSA 34, as discussed above for the embodiment of FIG. 2A, bonded to an inner surface of the silicone amalgamating tape 32 and forming the adhesive surface 30. The closure member 28c is shown adhered to the outer surface (surface facing radially outwardly relative to the central longitudinal axis 20) of the silicone-based coating 26, as discussed above for the embodiment of FIG. 2B, and can include a release film(s), as desired.

The interlaced yarns 24, in a preferred embodiment of FIG. 3A, are woven, including warp yarns 36 extending generally parallel to the central longitudinal axis 20 and weft yarns 38 extending generally transversely to the central longitudinal axis 20. The warp yarns 36 can be woven with the weft yarns 38 in any desired weave pattern, including a pain weave, twill weave, satin weave or basket weave, for example, with the plain weave pattern being preferred to provide a smooth, stable and uniform protection pattern, with the smoothness facilitating bonding of the silicone-base coating 26 to the outer surface 17. The warp yarns 36 can be provided entirely from the multifilaments 24a, with the multifilaments 24a being resistant to heat (high temperature resistant) and the weft yarns can be provided including the monofilaments 24b, with the monofilaments 24b also being resistant to heat (high temperature resistant), while also having high abrasion resistance. Further yet, if desired to provide the wall 12 as being self-wrapping, the monofilaments 24b can be provided as being heat-settable, thereby be able to be heat-set to impart a heat-formed bias in the wall 12 to maintain the opposite edges 16, 18 in overlapping relation with one another, absent an externally applied force sufficient to overcome the internal bias. Of course, the external force can be intentionally applied to spread the opposite edges 16, 18 away from one another during installation of the sleeve 10 about the elongate member 14, whereupon the externally applied force can be released to allow the bias to automatically return the opposite edges 16, 18 into their overlapping relation. The weft yarns 38 can further include the multifilaments 24a being resistant to heat, with the weft monofilaments 24b and weft multifilaments 24a being provided in any desired ratio, and in one presently preferred embodiment, the weft monofilaments 24b and weft multifilaments 24a can be woven in alternating relation with one another in a 1:1 ratio.

The warp multifilaments 36, 24a can be provided as meta-aramid having a denier between about 100-3000tex, and the weft multifilaments 38, 24a can be provided having a denier between about 50-1000tex. The weft monofilaments 38, 24b can be provided as PEEK having a diameter between about 0.1-0.5 mm. With the weft multifilaments 38, 24a having a reduced effective diameter than the warp multifilaments 36, 24a, an increased weave tightness and density can be achieved to provide enhance protection to the elongate member 14.

In accordance with another aspect of the disclosure, with reference to FIGS. 3B and 3C, the textile sleeve 10b, 10c, respectively, can be knitted or braided with the aforementioned multifilaments 24a and monofilaments 24b. It is to be recognized that any desired combination of the multifilaments 24a and/or monofilaments 24b can be used to form the knitted or braided interlaced yarns 24.

In accordance with another aspect of the invention, a method of constructing a textile sleeve 10a, 10b, 10c is provided. The method includes interlacing heat-resistant yarn 24 to form an interlaced layer 23 of a wall 12 having opposite edges 16, 18 extending lengthwise between opposite ends 19, 21, with the opposite edges 16, 18 being configured to be wrapped about a central longitudinal axis 20 to bound the elongate member 14 within an enclosed cavity 22. The method further includes bonding a silicone-based coating 26 on an outer surface 17 of the interlaced layer 23. The method further includes fixing a closure member 28a, 28b, 28c along one of the opposite edges 18, and providing the closure member 28a, 28b, 28c having an adhesive surface 30 configured for adhesion to an outer surface 17 of the wall 12 to maintain the opposite edges 16, 18 of the wall 12 in overlapping relation with one another.

The method can further include interlacing the yarns 24 with one another in a weaving process, a knitting process, or a braiding process. If woven, the method can further include weaving the yarns including warp yarns 36 extending generally parallel to the central longitudinal axis 20, with the warp yarns 36 being provided entirely as multifilaments 24a resistant to heat, and weft yarns 38 extending generally transversely to the warp yarns 36, with the weft yarns 38 including monofilaments 24b resistant to heat.

In accordance with another aspect, the weft yarns 38 can further include both monofilaments 24b and multifilaments 24a resistant to heat.

The method can further include providing the warp multifilaments 36, 24a having a denier between about 100-3000tex and providing the weft multifilaments 38, 24a having a denier between about 50-1000tex.

The method can further include providing the weft monofilaments 24b having a diameter between about 0.1-0.5 mm.

Further yet, the method can include weaving the warp yarns 36 and the weft yarns 38 in one of a plain, twill, basket, or satin weave pattern.

The method can further include weaving the weft monofilaments 24b and weft multifilaments 24a in alternating relation with one another along the entirety of the length of the wall 12, such that the monofilaments 24b and weft multifilaments 24a are provided in a 1:1 ratio.

The method can further include providing the silicone-based coating 26 having a thickness between about 0.1-3.0 mm, and in one exemplary embodiment, a thickness between about 0.1-1.00 mm.

The method can further include providing the silicone-based coating 26 including at least one of a flame retardant and a heat stabilizer, thereby allowing the sleeve to withstand exposure to high heat and fire for a predetermined amount of time, including up to about 2 hours, while protecting the elongate member therein against damage.

The method can further include providing the closure member 28 including a silicone pressure sensitive adhesive 30.

The method can further include providing the silicone pressure sensitive adhesive 30 being configured for fixed adhesion to the inner surface 15 of the wall 12 and to an outer surface 17 of the wall 12.

The method can further include providing the closure member 28 including a silicone amalgamating tape 32.

The method can further include providing the silicone amalgamating tape 32 having a silicone pressure sensitive adhesive 34 bonded thereto, with the silicone pressure sensitive adhesive 34 being configured for adhesion to an outer surface of the silicone-based coating 26.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A textile sleeve for routing and protecting an elongate member, comprising:
a wall including an interlaced textile layer having an inner surface and an opposite outer surface extending widthwise between opposite edges and extending lengthwise between opposite ends, said opposite edges being configured to be wrapped about a central longitudinal axis to bound the elongate member within a cavity bounded by said inner surface, said interlaced textile layer being formed of yarns interlaced with one another, wherein a least some of said yarns include multifilaments resistant to heat and monofilaments resistant to heat;
a silicone-based coating adhered to said outer surface of said textile layer; and
a closure member fixed along one of said opposite edges, said closure member having an adhesive surface configured for adhesion to an outer surface of said wall to maintain said opposite edges of said wall in overlapping relation with one another.

2. The textile sleeve of claim 1, wherein said yarns include warp yarns extending generally parallel to said central longitudinal axis and weft yarns extending generally transversely to said central longitudinal axis, said warp yarns being woven with said weft yarns.

3. The textile sleeve of claim 2, wherein said warp yarns are provided entirely from said multifilaments resistant to heat and said weft yarns are provided including said monofilaments resistant to heat.

4. The textile sleeve of claim 3, wherein said weft yarns are provided including said multifilaments resistant to heat.

5. The textile sleeve of claim 4, wherein said multifilaments resistant to heat are provided as meta-aramid.

6. The textile sleeve of claim 4, wherein said warp multifilaments resistant to heat are provided having a denier between about 100-3000dtex and said weft multifilaments resistant to heat are provided having a denier between about 50-1000dtex.

7. The textile sleeve of claim 6, wherein said monofilaments resistant to heat are provided having a diameter between about 0.1-0.5 mm.

8. The textile sleeve of claim 5, wherein said monofilaments resistant to heat are provided as PEEK.

9. The textile sleeve of claim 1, wherein said silicone-based coating includes at least one of a flame retardant and a heat stabilizer.

10. The textile sleeve of claim 1, wherein said silicone-based coating has a thickness between about 0.1-3.0 mm.

11. The textile sleeve of claim 1, wherein said closure member is a silicone pressure sensitive adhesive.

12. The textile sleeve of claim 11, wherein said silicone pressure sensitive adhesive is configured for fixed adhesion to said inner surface and to said outer surface of said wall.

13. The textile sleeve of claim 1, wherein said closure member includes a silicone amalgamating tape.

14. The textile sleeve of claim 13, wherein said closure member includes a silicone pressure sensitive adhesive bonded to said silicone amalgamating tape.

15. A method of constructing a textile sleeve for routing and protecting an elongate member against arcing, exposure to high temperatures and fire, abrasion, and fluid ingress, comprising:
interlacing heat-resistant yarn to form an interlaced textile layer of a wall having opposite edges extending lengthwise between opposite ends, with the opposite edges being configured to be wrapped about a central longitudinal axis to bound the elongate member within an enclosed cavity;
bonding a silicone-based coating on an outer surface of the interlaced textile layer; and
fixing a closure member along one of the opposite edges, with the closure member having an adhesive surface configured for adhesion to an outer surface of the silicone-based coating to maintain the opposite edges in overlapping relation with one another.

16. The method of claim 12, further including interlacing the yarns with one another in a weaving process.

17. The method of claim 16, further including weaving the yarns including warp yarns extending generally parallel to the central longitudinal axis entirely from multifilaments resistant to heat and weft yarns extending generally transversely to the warp yarns including monofilaments.

18. The method of claim 17, further including heat-setting the monofilaments to impart a heat-formed bias in the wall to maintain the opposite edges in overlapping relation with one another.

19. The method of claim 18, further including weaving the weft yarns including multifilaments resistant to heat.

20. The method of claim 19, further including providing the warp multifilaments resistant to heat having a denier between about 100-3000dtex and providing the weft multifilaments resistant to heat having a denier between about 50-1000dtex.
